(19) United States
(12) Patent Application Publication
(10) Pub. No.: US 2012/0060297 A1
(43) Pub. Date: Mar. 15, 2012

(54) Vehicle wheel changing system

(76) Inventors: Linda Hoover, West End, NC (US); Kenneth R. Westcott, West End, NC (US)

(21) Appl. No.: 12/807,744

(22) Filed: Sep. 13, 2010

(51) Int. Cl. B60B 29/00; B23P 17/00

(52) U.S. Cl. 7/100; 29/426.1

(57) ABSTRACT

A multi-purpose tool for removing and attaching vehicle wheels. The tool comprises parts, which may be combined to make components. In a first aspect of the invention the lifting component comprises a handle and a base plate, which may be used to lift, lower, position and transport a wheel; one variant of the base plate having a wheel or roller. In a second aspect of the invention a tool for removing and replacing a hubcap is made from a portion of the handle. In a third aspect of the invention a lug removal component is either provided as a novel lug wrench or may be made from the novel lug wrench combined with a portion of the handle.

### FIELD

The present invention relates to the field of automotive or vehicle tools; more specifically the invention comprises an integrated tool for changing (removing and installing) a vehicle wheel.

### BACKGROUND

Vehicles comprise cars (or automobiles), trucks, pickups, SUVs, and trailers having wheels upon which are mounted rubber tires. Road debris and detritus, or excessive wear, heat etc., cause tires to deflate, sometimes quite rapidly and unexpectedly. The solution, of course, is to change the wheel and replace it with a spare wheel having a functional tire.

Most vehicle wheels are quite large and heavy, with truck or trailer tires exceeding eighty pounds in weight. And, with current emphasis on utilizing every cubic inch of vehicle space—especially on automobiles—there is a definite need for a compact tool for changing wheel—the tool stored somewhere in the vehicle.

Also, with at least half of the drivers being female, a tool facilitating the removal and replacement of heavy wheels is even more desirable.

Such a tool would clearly be welcome to millions of vehicle drivers.

### OBJECTS AND ADVANTAGES

Therefore, it is an object of the present invention to provide a wheel-changing tool that may be arranged in a compact way so the tool may be stored in a small space.

Another object is a tool that may be unfolded or assembled quickly for use in replacing a vehicle wheel.

And another object is a tool with components that may be used for multiple purposes.

And yet another object is a tool that is used to lift and hold a wheel in a required position while the wheel is being replaced.

And another object is a tool that may transport a wheel when it is removed.

Other objects and advantages of the invention will appear from the disclosure to follow. In the disclosure, reference is made to the accompanying drawings, which form a part hereof and in which is shown by way of illustration by an exemplary embodiment in which the invention may be practiced. This exemplary embodiment will be described in sufficient detail to enable those skilled in the art to practice the invention, and it is to be understood that other embodiments may be utilized and that structural changes may be made in details of the embodiments without departing from the scope of the invention.

### SUMMARY

In accordance with the recited objects of the present invention, a compact and novel wheel changing system embodied as a tool comprising a lifting component for lifting, holding and positioning a vehicle wheel. The lifting component has a base plate that engages and supports a vehicle wheel during replacement. The lifting component further comprises a multi-purpose handle for operating the lifting component. The handle serves as a lever for operating the lifting component whereby the lifting component may lift and hold a very heavy wheel by application of minimal force applied to the handle.

A modified lug-wrench is included, wherein the lug-wrench may be attached to a portion of the handle to provide additional leverage when using the lug wrench.

The handle comprises two sub-components, which may be separated for additional wheel changing operations: (1) a handle that is grasped by an operator to apply force to the lifting component, and for supplying force to the lug-wrench, and; (2) a hubcap tool having means for prying a hub-cap from a wheel and also including a rubber mallet for replacing a hub-cap. The two sub-components of the handle may be joined together and attached to the lifting component.

The handle may be disconnected from the hubcap remover in order to use the handle to apply force to the lug-wrench. The handle is configured at one end with a male fitting that is received and held by a female fitting in the lug-wrench. The handle may be disconnected from the lug-wrench and re-attached to the hubcap remover, then the combined handle and hubcap remover is attached to the lifting component. The hubcap tool is made to pry a hubcap from a wheel in order to permit the operator of the tool to engage and remove lug nuts fastening the wheel to the vehicle. The hubcap tool also functions as a mallet or hammer for securing the hubcap to the wheel.

### BRIEF DESCRIPTION OF DRAWINGS

### Labeling convention

In the accompanying figures or drawings illustrating an exemplary embodiment, each feature of the embodiment will be assigned a numeric label of the form FCxx, where:
F is the number of the figure
C is the number assigned to the component
Xx is number assigned to a sub-component

The following component assignments have been made to the exemplary embodiment:
100 base plate of lifting component
200 handle
210 first handle sub-component
220 second handle sub-component comprising a hubcap removal tool
300 lug wrench

### Included Figures

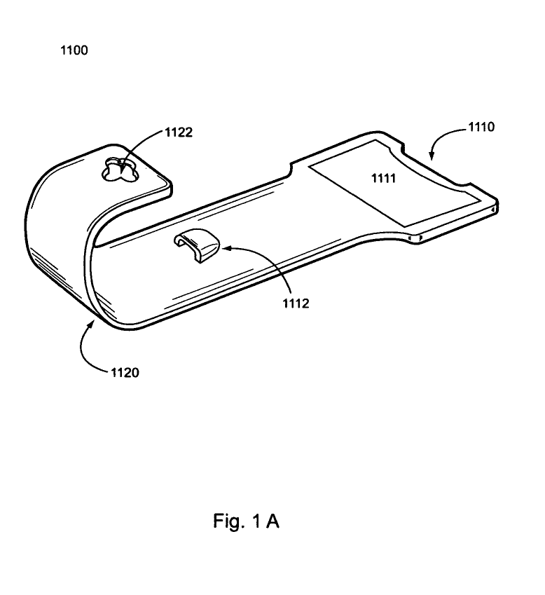

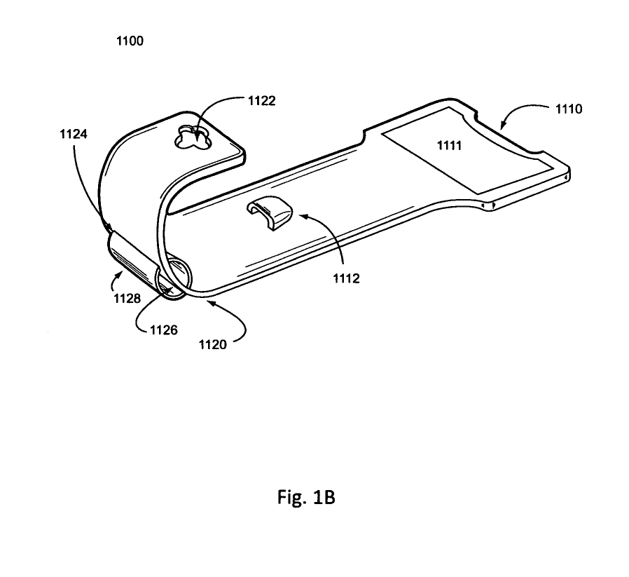

FIG. 1A shows an exemplary embodiment of the base plate as a sub-component of the lifting component.

FIG. 1B shows a variant of the base plate, the variant having a wheel (shown in the form of a rolling cylinder).

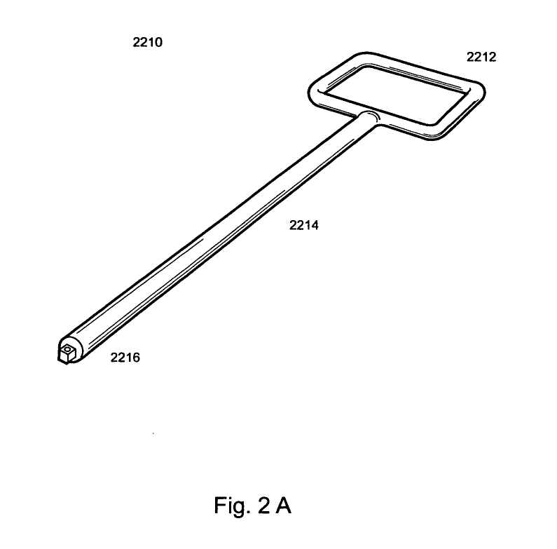

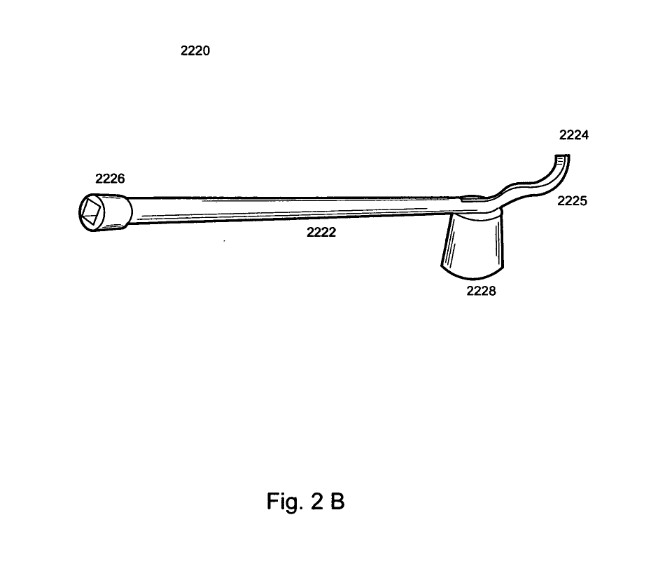

FIG. 2A shows a first sub-component of the handle, which has multiple purposes; the first purpose being a part of the lifting component functioning as a means of manipulating and operating the base plate, the second purpose is as an extension arm to the lug wrench to increase leverage.

FIG. 2B shows a second sub-component of the lifting component, and configured and made to operate as a removal and replacement tool for hubcaps. FIG. 2B shows the tool equipped with a rubber mallet for replacing the hubcap.

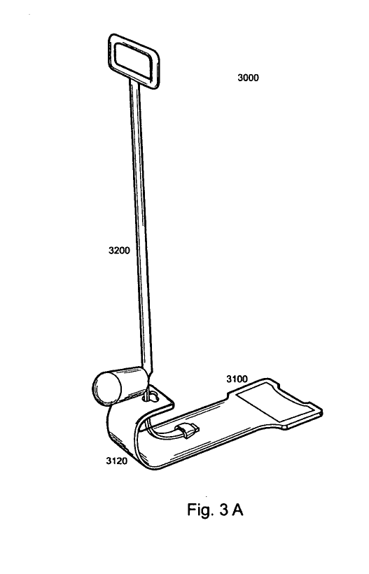

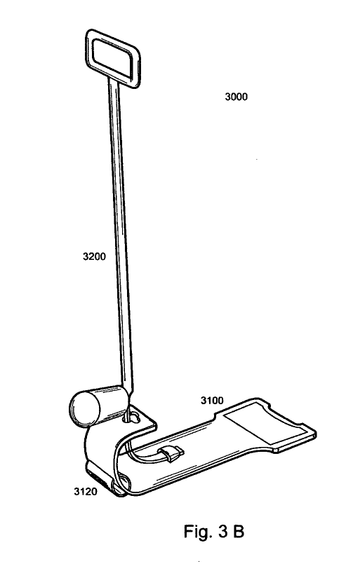

FIG. 3A shows a first version of the lifting component comprising the handle and the base plate.

FIG. 3B shows a second version of the lifting component having a wheel for rolling the lifting component.

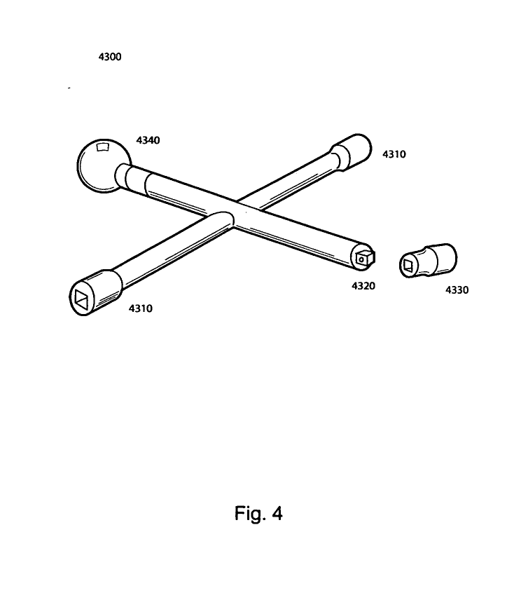

FIG. 4 shows a lug removing tool, which may be attached to the first sub-component of the handle.

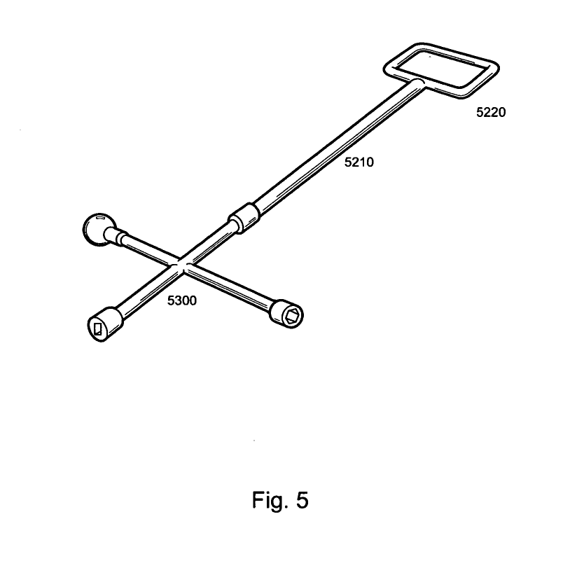

FIG. 5 shows the first sub-component of the handle attached to the lug wrench to make a lug removal component.

### DETAILED DESCRIPTION

### An Exemplary Embodiment

The accompanying figures convey and exemplary embodiment of the invention. It will be understood that other variants and modifications are possible in view of the detailed description that follows.

### Lifting Component

The lifting component is shown in FIG. 1A, FIG. 1B, 2A, 2B, 3A and 3B.

The lifting component comprises a base plate and a handle. A first version of the base plate is shown in FIG. 1A and a second version is shown in FIG. 1B; the second version having a wheel. The handle is shown as two sub-components, which are shown in FIG. 2A and FIG. 2B. The first sub-component, shown in FIG. 2A, is attached to the second component in FIG. 2B and the joined sub-components are attached to the base plate FIG. 1A or FIG. 1B to make the lifting component—shown in FIG. 3A and 3B.

The first sub-component shown in FIG. 2A may also be attached to a novel lug wrench shown in FIG. 4, to make a combined lug removal tool shown in FIG. 5.

### Lug Wrench Component

The lug removal component is used to remove lug nuts and has two configurations. The first configuration is shown in FIG. 4. The second configuration is shown in FIG. 5.

### Construction of Components

The tool will be used in ways that require the various parts to be made from durable materials having high strength, and preferably to be rust and corrosion resistant.

### Detail Description of Details of the Figures

With reference to FIG. 1A and FIG. 1B, the base plate 1100 is made generally in the shape shown. The base plate 1100 has a distal end 1110 that engages and fits beneath a wheel, the wheel resting upon 1110. The wheel rests upon the surface labeled 1111, which may be a non-skid surface or a depression adapted to receive and hold a wheel. In use, the base plate 1100 is positioned under the wheel so that half the wheels tread rests upon the surface 1111. An operator engages the tool by pushing the handle back and the wheel lifts and tilts forward resting on the edge of the distal end 1110 of the base plate.

At the proximal end 1120 of the base plate 1100, the base plate is shaped generally as shown, whereby the proximal end 1120 of the base plate 1100 serves as a fulcrum of the base plate 1100, which, in turn, operates to lift a wheel resting on the surface 1111.

FIG. 1B shows a variant of the base plate 1100, the variant having a wheel or roller 1128. The wheel or roller 1128 fits within a slot 1124 made in the proximal end 1120 of the base plate 1100. The slot 1124 is configured to receive the wheel or roller 1124 and to provide an axle 1126 for the wheel or roller 1128.

The proximal end 1120 of the base plate in FIG. 1A functions as a fulcrum for lifting a wheel. In FIG. 1B the proximal end 1120 contains a wheel or roller 1128 which acts as the fulcrum for lifting the wheel.

With reference to FIG. 1A and FIG. 1B, the proximal end 1120 is made with an opening 1122 and a receptacle 1112. The handle shown in FIG. 2A (first sub-component) and FIG. 2B (second sub-component) is attached to the base plate 1100 by passing the distal end 2224 of the second sub-component (FIG. 2B 2220) though opening 1122 and fitting the distal end 2224 into the receptacle 1112. The handle and base are shown combined in FIG. 3A and 3B.

FIG. 3A and 3B show the lifting component in assembled form. The figures show the lifting component comprising the handle 3200 and the base plate 3100. FIG. 3B shows the base plate having a wheel or roller. To operate the lifting component, a wheel is rolled onto the distal end of the base plate 3100 so that half the width of the wheel tread rests on the distal end of the base plate 3100. The operator stands parallel to the base plate with one hand on the tire and the other on the handle and pushes back on the handle. A section 3120 of the proximal end of the base plate 3100 operates as a fulcrum, and by action of the operator pulling or pushing the handle 3200, the wheel resting upon the distal end of the base plate 3100 is raised up or lowered. If the base plate 3100 has a wheel or roller, the lifting component may be transported by rolling as dictated by the operator. Otherwise the lifting component may be slid on the fulcrum 3120 of the proximal end.

FIG. 2A shows the first sub-component 2210 of the handle. The sub-component 2210 comprises a grasping portion 2212, and length 2214 and an attaching end 2216. The grasping portion 2212 is held by an operator, who transmits forces through the handle length 2214 to the attaching end 2216. The attaching end 2216 is made with a fitting that facilitates the handle sub-component 2210 to be attached either to the second handle sub-component (shown in FIG. 2B) or to the lug wrench shown in FIG. 4.

FIG. 2B shows the second handle sub-component 2220, which may also be used as a device for removing and replacing hubcaps. The proximal end of the sub-component 2220 is made with an opening 2226 that receives and holds the fitting of the attaching end 2216 shown in FIG. 2A. The sub-component 2220 in FIG. 2B is made with a length 2222 to provide leverage when the distal end 2224 is applied to remove a hubcap. The distal end 2224 is configured to fit between a hubcap and a wheel rim and uses the fulcrum 2225 to pry the hubcap loose when force is applied to the length 2222. The sub-component 2220 is has a rubber mallet-head 2228 used for striking when replacing a hubcap.

### The Lug Wrench

FIG. 4 shows the lug wrench 4300. The lug wrench uses a plurality of 6 point (hexagonal) sockets.

The lug wrench 4300 has four arms 4310, 4320, 4340. One arm 4340 of which has a ‘handgrip’ (shown as a ball in the drawing) at the end that rests in the user's hand and allows for free rotation of the lug wrench 4300 by applying pressure to either of the two arms 4310 positioned at right angles to the arm with the handgrip. (The reason for this action is to allow for rapid spinning of the tool while removing/replacing the lug nuts.)

The arm with the handgrip 4340 is opposite the arm with the male adapter 4320. The male adaptor 4320 can use a multiplicity of sockets 4330 of different sizes.

The arms 4310 at right angles to the straight line from the handgrip 4340 to the male socket attachment 4320 are used to loosen/tighten the lug nuts. There is a female adapter on the end of each of the arms 4310. The female adapters allow for the connection of the handle component 2210 that contains the male adapter. When used in combination, the lug wrench arm, with the additional handle component 2210 supplies significant additional leverage capability for loosening and tightening lug nuts.

The two arms of the lug wrench, with female adaptors 4310, permit the attachment of handle 5210 to provide additional leverage in the removal/replacement of lug nuts. With the handle identified in FIG. 2A inserted via connector 2216 into either adaptor 4310, significant increase torque can be applied as shown in the combination of lug wrench 5300 and handle 5210 as shown in FIG. 5.

When removing or replacing a lug nut the ball identified as 4340 rests in the operators hand and is used to stabilize the 4320/4330 combination on the lug nut.

### DISCLOSURE SUMMARY

Although the present invention has been disclosed as a single exemplary embodiment, it is to understood that various modifications, alterations and adaptations may be made by those skilled in the art without departing from the spirit and scope of the invention set forth in the following claims.

We claim:

1. A tool for changing a vehicle wheel, the tool comprising:
a lever surface having a distal end and a proximal end, having a portion acting as a fulcrum, wherein the distal end engages a portion of the wheel's lower road surface;
a lug-wrench for removing and replacing lug-nuts attaching the wheel to the vehicle, and;
a lever bar, attached to the lever surface, wherein the lever bar may be removed the lever bar first part adapted to be attached to the lug wrench, wherein the lever bar is separable and comprised of a first part and a second part, the lever bar first part providing additional leverage when the lug wrench is used, the lever bar second part a prying tool for prying a hubcap attached to the wheel, the prying tool comprising a mallet for hammering to attach the hubcap;
whereby a user of the tool operates the lever bar and lifts or lowers the wheel.

2. A vehicle wheel changing tool comprising a lug wrench and a lifting component for lifting and holding the wheel, wherein the lifting component comprises a lever bar configured to separate into a first part and a second part, the lever bar second part comprising a prying tool for prying loose a hubcap attached to the wheel, the lever bar second part further comprising a mallet for striking to attach a hubcap attached to the wheel.

3. The tool of claim 2, wherein the tool has a roller for rolling the tool.

4. A tool for a user to lift, hold and remove a vehicle wheel, the tool comprising:
a lifter having a proximal end, a fulcrum and a distal end that engages the road surface of the wheel, and;
a lever bar received by the proximal end, the lever bar operated by the user to lift and hold the wheel, wherein the lever bar may be detached, the lever bar separable into two parts, the second part configured as a pry for prying loose a hubcap attached to the wheel, the second part also configured as a mallet for striking and replacing the hubcap, and;
a lug wrench adapted to receive the lever bar first part and to be operated by the user to apply more leverage to a lug nut.

5. The tool of claim 4, wherein the proximal end has a roller for transporting the tool.

6. (A method of removing a vehicle wheel, the method comprising:
providing the tool of claim 44;
detaching the lever bar;
separating the lever bar into the first part and the second part;
using the lever bar second part to pry off the vehicle hubcap;
attaching the lever bar first part to the lug wrench;
removing lug nuts attaching the wheel;
joining the lever bar first part and the lever bar second part;
attaching the lever bar to the lifter proximal end;
positioning the lifter distal end to engage the road surface of the wheel, and;
lifting the wheel off the vehicle.
